(19) United States
(12) Patent Application Publication
(10) Pub. No.: US 2026/0261085 A1
(43) Pub. Date: Sep. 3, 2026

(54) RF CONNECTOR

(71) Applicant: Samtec, Inc., New Albany, IN (US)

(72) Inventor: Thomas A. HALL, III, New Albany, IN (US)

(21) Appl. No.: 18/881,950

(22) PCT Filed: Jul. 7, 2023
(86) PCT No.: PCT/US2023/027084

§ 371 Date: Jan. 7, 2025

Related U.S. Application Data
(60) Provisional application No. 63/359,477, filed on Jul. 8, 2022.

(51) Int. Cl. H01R 24/50; B33Y 80/00; H01R 43/20; H01R 103/00

(52) U.S. Cl. CPC H01R 24/50; B33Y 80/00; H01R 43/20; H01R 2103/00

(57) ABSTRACT

An electrical connector includes a connector housing and a core that is inserted into the connector housing. The core includes a shell, a center conductor, a ground conductor, and an insulating spacer provided between the center conductor and the ground conductor. Internal components of the core can be manufactured by an additive manufacturing process.

### CROSS REFERENCE TO RELATED APPLICATIONS

This application claims the benefit of U.S. Patent Application No. 63/359,477 filed on Jul. 8, 2022. The entire contents of this application are hereby incorporated by reference.

### BACKGROUND OF THE INVENTION

### 1. Field of the Invention

The present invention generally relates to radio-frequency (RF) or coaxial-board connectors.

### 2. Description of the Related Art

Known RF or coaxial-board connectors, such as compression connectors, have generally been manufactured as unitary components with predetermined electrical characteristics. Accordingly, a user may find it difficult to properly tune or impedance match known RF or coaxial-board connectors to a particular application. In addition, the structure of known RF or coaxial-board connectors are difficult to repair and are typically completely replaced during maintenance or if an internal electrical component fails.

### SUMMARY OF THE INVENTION

Preferred embodiments of the present invention provide electrical connectors that include a connector housing and a core that can be inserted into the connector housing. At least a portion of the core can be manufactured by an additive manufacturing process.

Accordingly, an electrical connector can be provided that can be easily assembled, disassembled, and repaired. Further, since components of the core can be made by an additive manufacturing process, the core can be easily tuned or impedance matched for a predetermined application. The core can also be easily removed and replaced by another core to perform maintenance or to provide different electrical characteristics.

According to an embodiment of the present invention, an electrical connector can include a connector housing and a core that is removably inserted into the connector housing without physically damaging the core, physically damaging the connector housing, or both physically damaging the core and physically damaging the connector housing.

The core can include a center conductor, a ground conductor, and an insulating spacer provided between the center conductor and the ground conductor. The insulating spacer can include a dielectric material. The insulating spacer can include one or more void spaces. The insulating spacer can define a lattice structure. At least one of the center conductor and the ground conductor can be tapered along a length of the core. The center conductor can include a recess that receives a pin of a mating connector or cable, when the electrical connector is mated with the mating connector or cable.

The center conductor can be at least partially exposed from the core at a surface of the core that mates with a substrate. The ground conductor can be at least partially exposed from the core at a surface of the core that mates with a mating connector or cable when the electrical connector is mated with the mating connector or cable. The ground conductor can be at least partially exposed from the core at a surface of the core that mates with a substrate, when the electrical connector mates with the substrate. The portion of the ground conductor that can be at least partially exposed from the core can include a cut-out or recessed portion.

The connector housing can include a ridge located within a port of the connector housing. The core can include a beveled surface that mates with the ridge when the core is inserted into the connector housing.

According to an embodiment of the present invention, a method of manufacturing a core of an electrical connector can include a step of forming a portion of the core by an additive manufacturing process and a step of placing the portion of the core in a shell.

The additive manufacturing process can include a step of forming a center conductor, an insulating spacer, and a ground conductor. The insulating spacer can be located between the center conductor and the ground conductor. The insulating spacer can be formed with one or more void spaces. The void spaces can be formed in or can define a lattice structure. The insulating spacer can be formed to provide a predetermined dielectric constant. At least one of the center conductor and the ground conductor can be tapered along a length of the core.

According to an embodiment of the present invention, an RF compression connector can include a housing and an insertable and removable signal conductor located in the housing.

According to an embodiment of the present invention, an RF compression connector can include a housing and a core that can be removed and reinserted into the housing without damaging the housing or the core.

According to an embodiment of the present invention, an RF compression connector can include a housing and a field-repairable core.

According to an embodiment of the present invention, an RF compression connector can include a housing, a center conductor, and a dielectric spacer. The center conductor and the dielectric spacer can both be made by three-dimensional printing during a single printing process or a single printing routine.

The above and other features, elements, characteristics, steps, and advantages of the present invention will become more apparent from the following detailed description of the embodiments of the present invention with reference to the attached drawings.

### BRIEF DESCRIPTION OF THE DRAWINGS

FIG. 1 is a perspective top view of an RF connector mounted to a substrate.

FIG. 2 is a cross-sectional view of the RF connector and the substrate shown in FIG. 1.

FIG. 3 is a top view of the RF connector shown in FIG. 1.

FIG. 4 is a perspective top view of the substrate shown in FIG. 1.

FIG. 5 is a perspective top view of a core that is insertable into the RF connector shown in FIG. 1.

FIG. 6 is perspective bottom view of the core shown in FIG. 5.

FIG. 7 is a cross-sectional view of the core shown in FIG. 5.

FIG. 8 is a perspective top view of the core shown in FIG. 5 inserted into the RF connector shown in FIG. 1.

FIG. 9 is a perspective bottom view of the core shown in FIG. 5 inserted into the RF connector shown in FIG. 1.

FIG. 10 is a perspective view of an alignment peg that is insertable into the RF connector shown in FIG. 1.

FIGS. 11 and 12 are top and bottom cross-sectional views of the alignment peg shown in FIG. 10 being inserted into the RF connector shown in FIG. 1.

FIGS. 13 and 14 are top perspective views of the RF connector shown in FIG. 1 being mounted to the substrate shown in FIG. 1.

### DETAILED DESCRIPTION

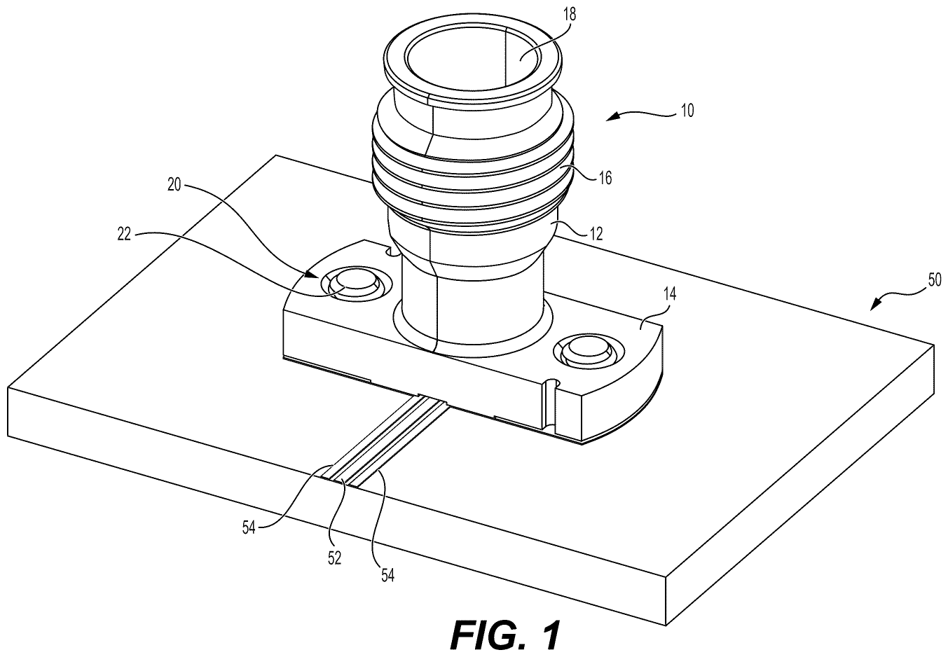

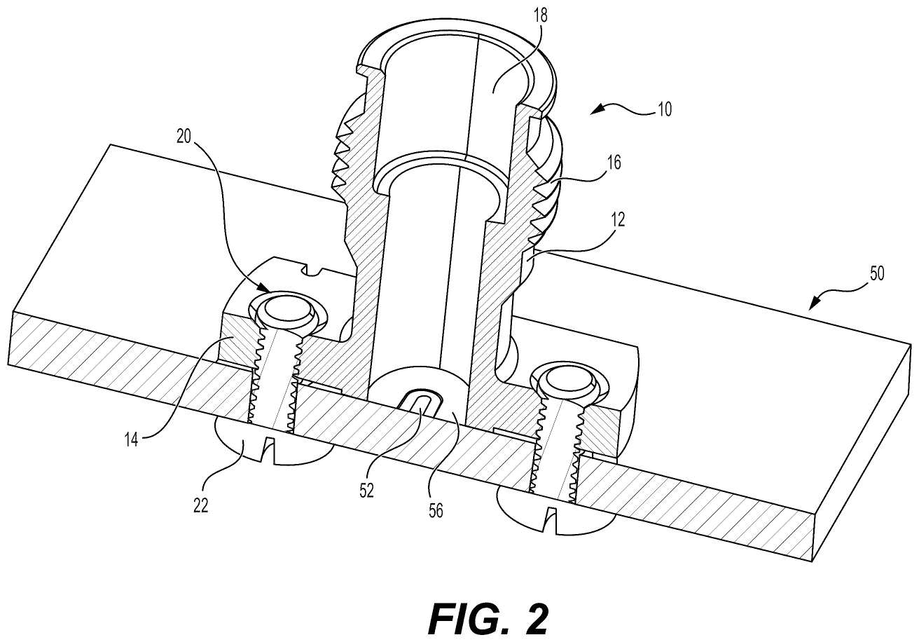

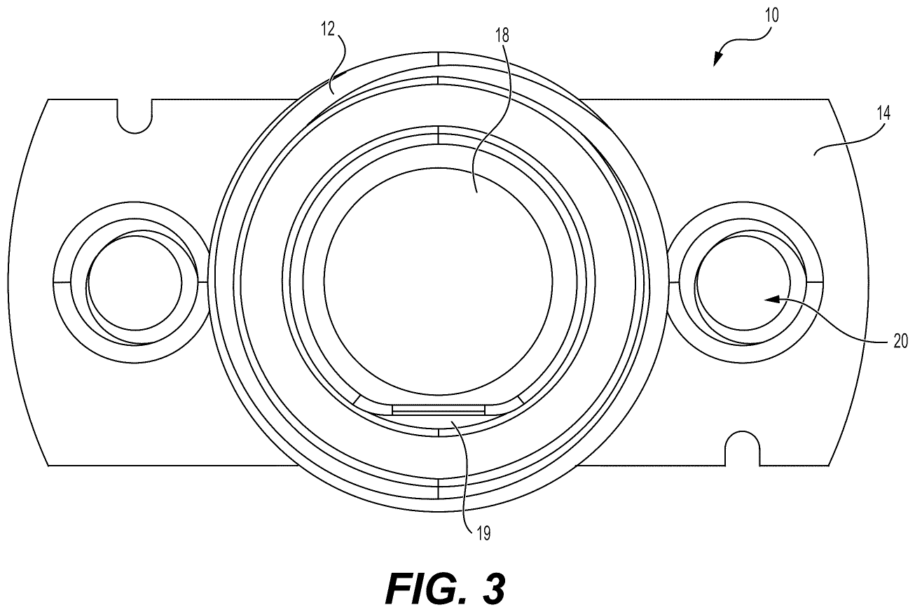

FIG. 1 is a perspective top view of an RF connector 10 mounted to a substrate 50, FIG. 2 shows a cross-sectional view of the RF connector 10 and the substrate 50, and FIG. 3 is a top view of the RF connector 10. The RF connector 10 can be, but is not limited to, a vertically mounted, RF compression connector 10.

As shown in FIGS. 1-3, the RF connector 10 can include a connector housing 12. The connector housing 12 can further define a connector base 14. The connector housing 12 and the connector base 14 can be unitary with one another or can be formed, machined, or cast as a single body. One or both of the connector housing 12 and the connector base 14 can be made from an electrically conductive material, for example, an electrically conductive metal.

The connector housing 12 can define external threads 16 adjacent to at least one port 18 of the RF connector 10. At least one or at least two connector fastener holes 20 can be defined by the connector housing 12 or the connector base 14. The RF connector 10 can also include a ridge 19 as an alignment feature, as discussed further below.

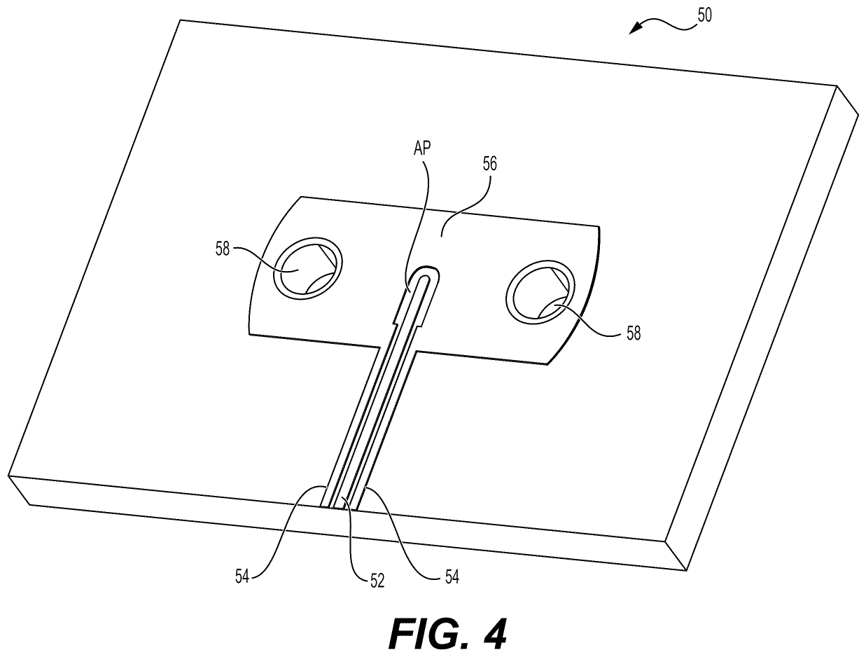

FIG. 4 is a perspective top view of the substrate 50 shown in FIG. 1. As shown in FIGS. 1-4, the RF connector 10 can be secured to the substrate 50 by screws 22 or the like that are inserted through substrate fastener holes 58 and received by the connector fastener holes 20. The substrate 50 further includes a signal trace 52 and one or more ground traces 54. Although FIGS. 1 and 4 show that two ground traces 54 can be provided in parallel with the signal trace 52 located therebetween in a stripline arrangement, the substrate 50 is not limited to this specific arrangement. The ground traces 54 connect with a ground plane 56 that can contact the electrically conductive material of the connector housing 12. Although the signal trace 52, the ground traces 54, and the ground plane 56 are shown as being provided on an outer surface of the substrate 50, one or more of the signal trace 52, the ground traces 54, and the ground plane 56 can be included in or can extend below the outer surface of the substrate 50.

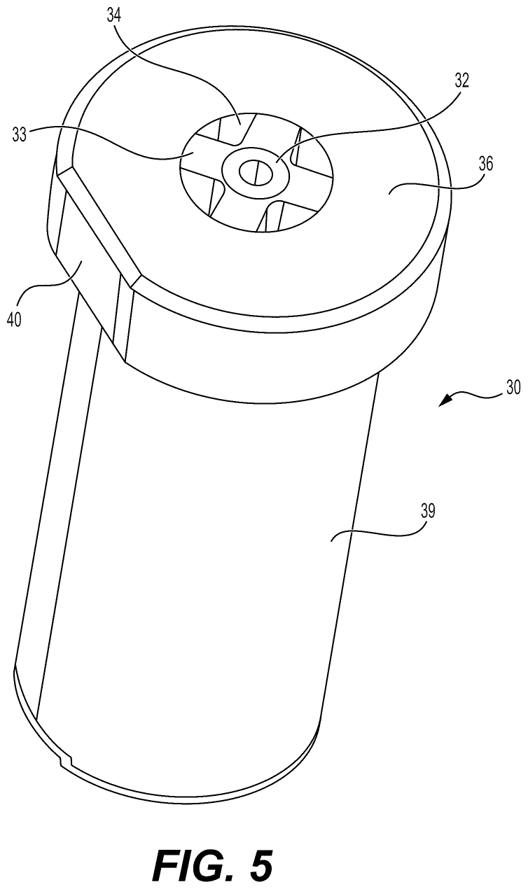

FIGS. 5-7 show perspective and cross-sectional views of a core 30 that is insertable into the RF connector 10 shown in FIG. 1. The core 30 includes a center conductor 31 that passes through the core 30 and that can conduct electrical signals and includes a ground conductor 35 that surrounds the center conductor 31 in a coaxial arrangement and that can be connected to ground. One end of the core 30 can include a connector interface pin 32, which can be defined by a recess in the center conductor 31. The connector interface pin 32 can receive a pin or conductor from a mating connector or cable, for example, a coaxial cable.

The center conductor 31 can be surrounded by one or both of a dielectric spacer 33 and a void space 34. The dielectric spacer 33 and the void space 34 can electrically isolate the center conductor 31 from the ground conductor 35. The dielectric spacer 33 and the void space 34 can define a lattice structure. As shown in FIG. 5, the dielectric spacer 33 can include four spokes that extend between the center conductor 31 and a shell 39 of the core 30, but the dielectric spacer 33 can include any number of spokes. A structure of the dielectric spacer 33 and the void space 34, and a material composition of the dielectric spacer 33, can be adjusted to provide predetermined electrical characteristics, for example, a predetermined dielectric constant. The ground conductor 35 can surround the center conductor 31, and the ground conductor 35 can be at least partially surrounded by the shell 39. The shell 39 can be plastic or another non-electrically conductive material.

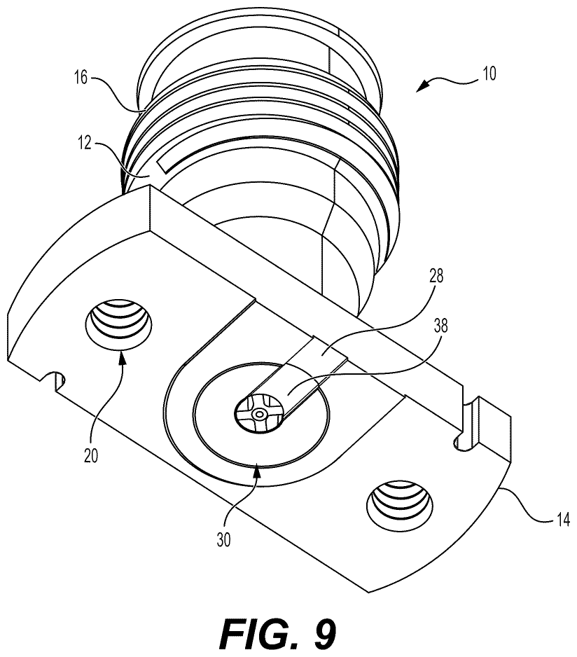

The ground conductor 35 can define both a connector ground 36 and a substrate ground 37 at different ends of the core 30, with the connector ground 36 and the substrate ground 37 being at least partially not covered by the shell 39. The connector ground 36 can be defined by a planar shape that can mate with a corresponding ground connection of a mating connector or cable. The substrate ground 37 can be defined by a planar shape that can mate with the ground plane 56 of the substrate 50. The substrate ground 37 can also include a core ground cut-out 38 in the substrate ground 37, as further discussed below with respect to FIG. 9.

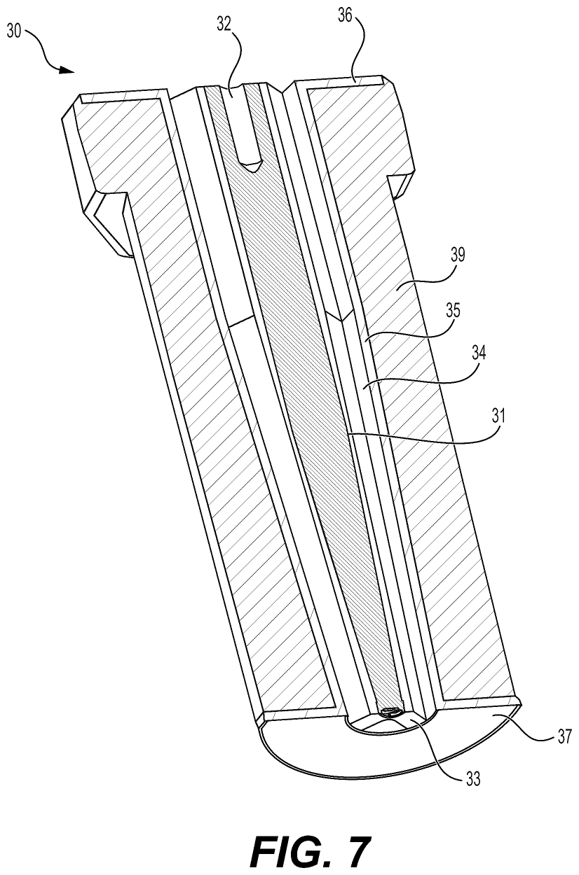

As shown in FIG. 7, one or more of the center conductor 31, the dielectric spacer 33, the void space 34, and the ground conductor 35 can have a tapered shape along a length of the core 30. In particular, providing tapered shapes of components in the core 30 can help to prevent reflectance. However, the shapes of the elements of the core 30 are not limited to those shown in the drawings, and can be modified according to predetermined electrical characteristics, for example, predetermined impedance characteristics and the like. One or more of the center conductor 31, the dielectric spacer 33, the ground conductor 35 and the shell 39 can be formed by an additive manufacturing process, for example, a three-dimensional printing process and/or a laser printing process.

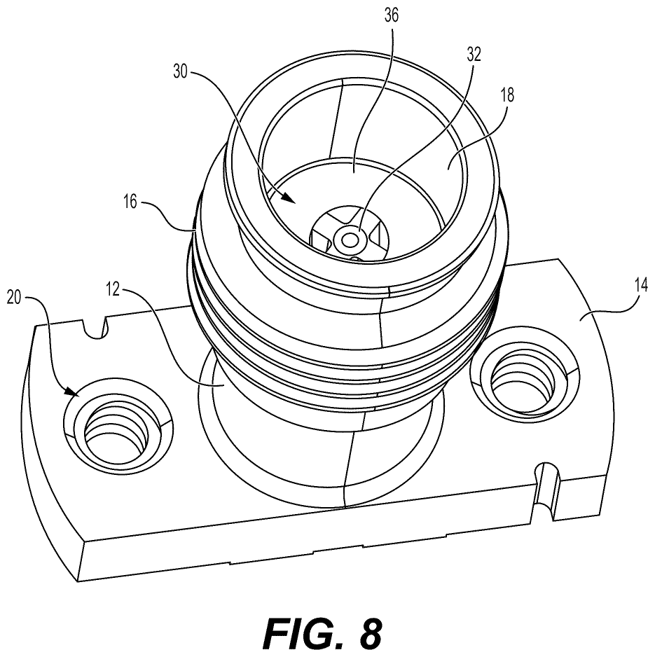

FIGS. 8 and 9 are perspective views of the core 30 shown in FIG. 5 inserted into the RF connector 10 shown in FIG. 1.

As shown in FIG. 8, the core 30 can be inserted into the RF connector 10 via the port 18, with the connector interface pin 32 and the connector ground 36 exposed in the port 18.

Accordingly, a mating connector or cable can be electrically connected to the connector interface pin 32 and the connector ground 36 of the core 30, and the mating connector or cable can be physically secured to the RF connector 10 by the external threads 16. Thus, the RF connector 10 and the core 30 can define, but are not limited to, a vertically mounted, RF compression connector. The port 18 can be located at an upper portion of the RF connector 10, such that the core 30 can be inserted into the RF connector 10 at the top of the RF connector 10. The core 30 can have a length that is approximately equal to a height of the RF connector 10. However, the length of the core 30 is not limited and may be shorter or longer than the length of the RF connector 10.

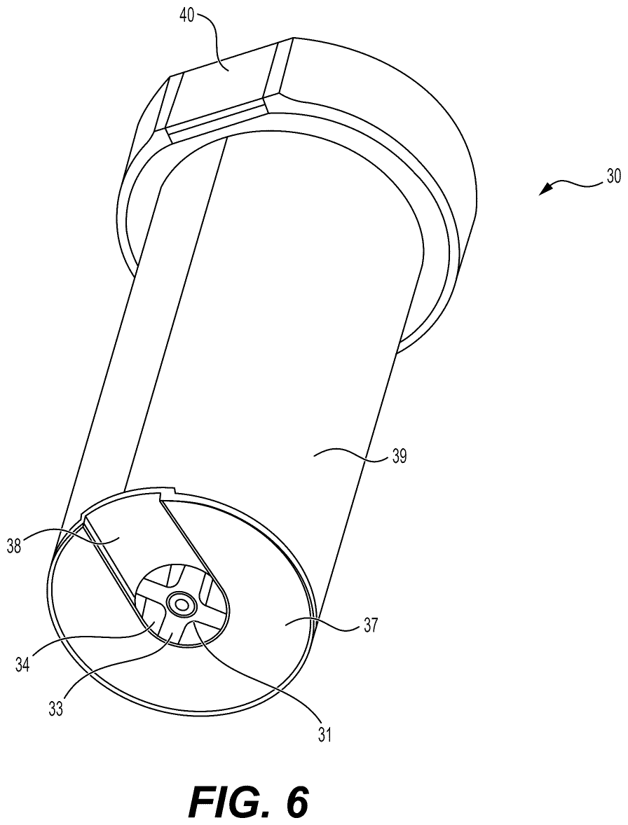

As shown in FIGS. 5 and 6, the core 30 can include a bevel 40 as an alignment feature. When the core 30 is inserted into the RF connector 10, the core can only be fully inserted into the RF connector 10 when the bevel 40 is aligned with the ridge 19 (shown in FIG. 3). The core 30 can be secured to the RF connector 10 by, for example, a press-fit connection, a press-fit and twist connection, an interference fit, glue, adhesive, or retention features provided on the shell 39.

As shown in FIG. 9, the RF connector 10 can further include a base ground cut-out 28, and the base ground cut-out 28 can be aligned with the core ground cut-out 38 when the core 30 is inserted into the RF connector 10. The core ground cut-out 38 and the base ground cut-out 28 provide a path for the signal trace 52 of the substrate 50 (as shown in FIGS. 1, 2, and 4) At least a portion of the substrate ground 37 can include a roughened surface or stress concentrators, for example, bumps or pyramidal shapes formed on the substrate ground 37. The roughened surface or stress concentrators can provide improved conductivity between the substrate ground 37 and the ground plane 56 by providing multiple physical and electrical connections between the substrate ground 37 and the ground plane 56.

According to the structure of the RF connector 10 and the core 30, an electrical connector, such as an RF connector 10, can be provided that can be easily assembled, disassembled, and repaired. For example, the core 30 can be field-repairable and can be replaced or repaired on-site and without returning the RF connector 10 or the core 30 to a manufacturer or the like and without removing or disconnecting the RF connector 10 from a mating substrate or host circuit board, for example, the substrate 50. Further, since the core 30 can be made by an additive manufacturing process, the core 30 can be easily tuned or impedance matched for a predetermined application. The core 30 can also be easily removed and replaced by another core to perform maintenance or to provide different electrical characteristics. For example, if a system impedance changes, rather than repopulate a substrate or host circuit board with new connectors, the core 30 can be removed and replaced with a new core 30 that has a different impedance. In addition, the RF connector 10 does not need to be machined during a manufacture process, since an impedance can be tuned or set according to the core 30.

The RF connector 10 can include only a single stepped portion, and an interior width of the RF connector 10 can be constant or substantially constant between the stepped portion and a mating substrate or host circuit board, for example, the substrate 50. More than 60%, more than 70%, more than 80%, more than 90%, or more than 95% of a length of the center conductor 31 can be at least partially surrounded by the shell 39. Stated another way, the shell 39 can extend an entire longitudinal length of the center conductor 31, can extend at least 95% of an entire longitudinal length of the center conductor 31, can extend at least 90% of an entire longitudinal length of the center conductor 31, can extend at least 75% of an entire longitudinal length of the center conductor 31 or can extend at least 50% of an entire longitudinal length of the center conductor 31.

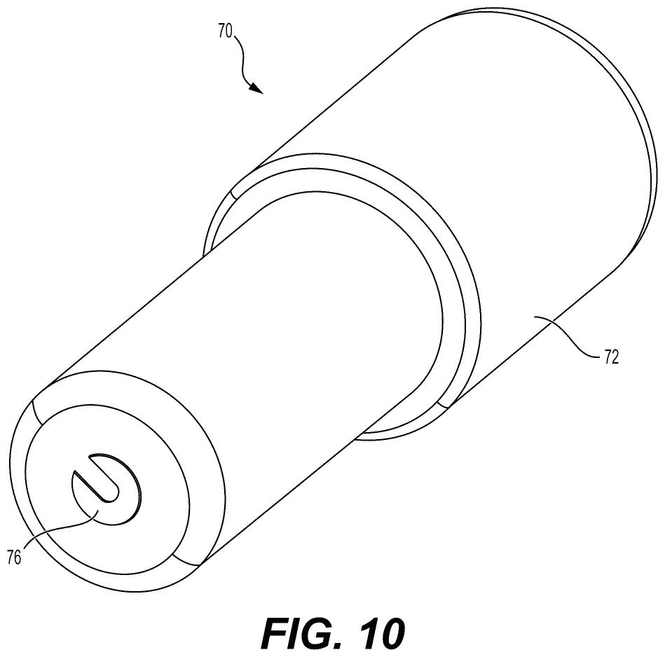

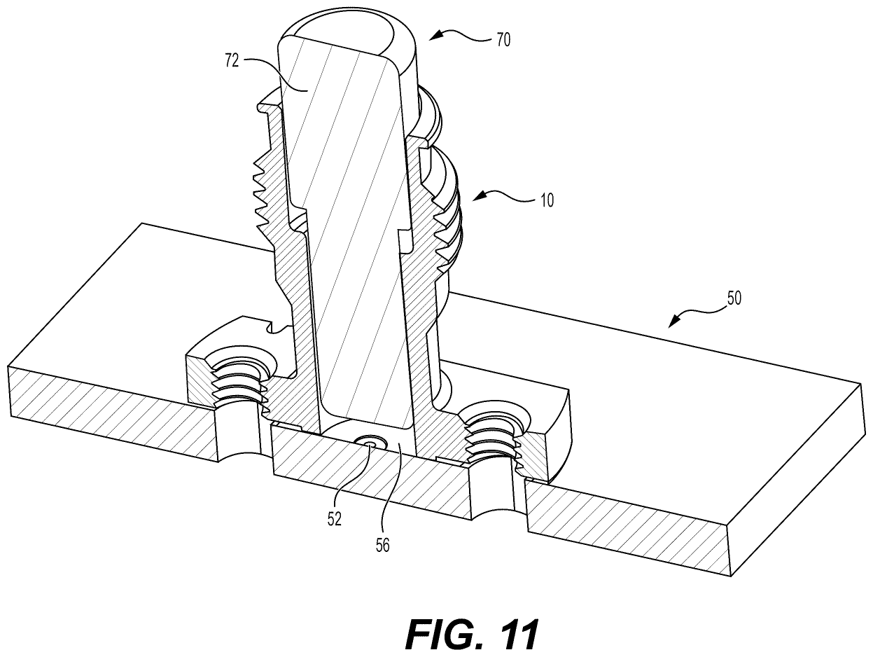

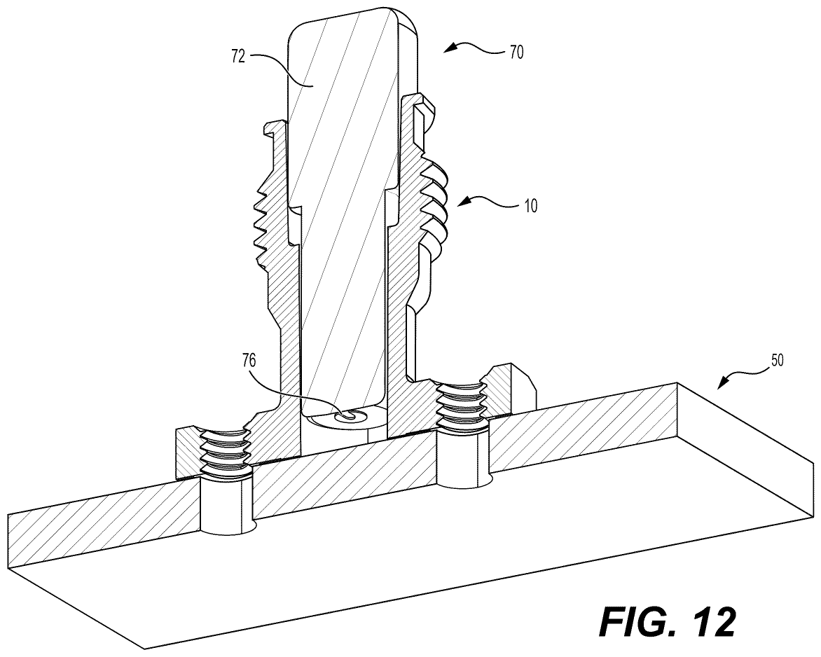

FIG. 10 is a perspective view of an alignment peg 70 that is insertable into the RF connector 10 or connector housing 12 shown in FIG. 1. FIGS. 11 and 12 are top and bottom cross-sectional views of the alignment peg 70 being inserted into the RF connector 10. The alignment peg 70 can include a main body 72 and a raised, embossed portion 76. The main body 72 can be made of plastic or a dielectric material and can include a shape that corresponds to an inner space or shape of the connector base 14 of the RF connector 10. The embossed portion 76 can define a protrusion from the main body 76 and can have a semi-circular shape or other shape that can mate with an anti-pad AP space between the signal trace 52 and the antipad or ground plane 56 of the substrate 50. That is, the raised embossed portion 76 can engage with traces on the substrate 50 and a space or shape defined between the signal trace and the antipad AP. Alternatively, a raised embossed portion 76 can also be formed at the end of the core 30 (FIG. 6). An RF connector 10 (FIG. 9) can include a housing, such as a connector housing 12 (FIG. 9) and a core 30 (FIG. 9) that can be or is configured to be repeatability inserted and removed from the connector housing 12 without damaging the connector housing 12 or the core 30. The core 30 can further include a raised embossed portion 76 (FIG. 10) configured to engage, in only one possible orientation, with a correspondingly shaped space or shape defined between a substrate signal trace 52 (FIG. 11) and an associated ground plane 56 (FIG. 11) of a substrate 50 (FIG. 11). The core 30 can further include a center conductor 31 (FIG. 7) that defines a raised embossed portion 76 (FIG. 10) configured to engage, in only one possible orientation, with a correspondingly shaped space or shape defined between a substrate signal trace 52 (FIG. 11) and an associated ground plane 56 (FIG. 11) of a substrate 50 (FIG. 11).

The alignment peg 70 can be made by an additive manufacturing process, for example, a three-dimensional (3D) printing process. The embossed portion 76 can be provided in or on the alignment peg 70 by an additive manufacturing process, for example, a three-dimensional (3D) printing process, or a laser printing process.

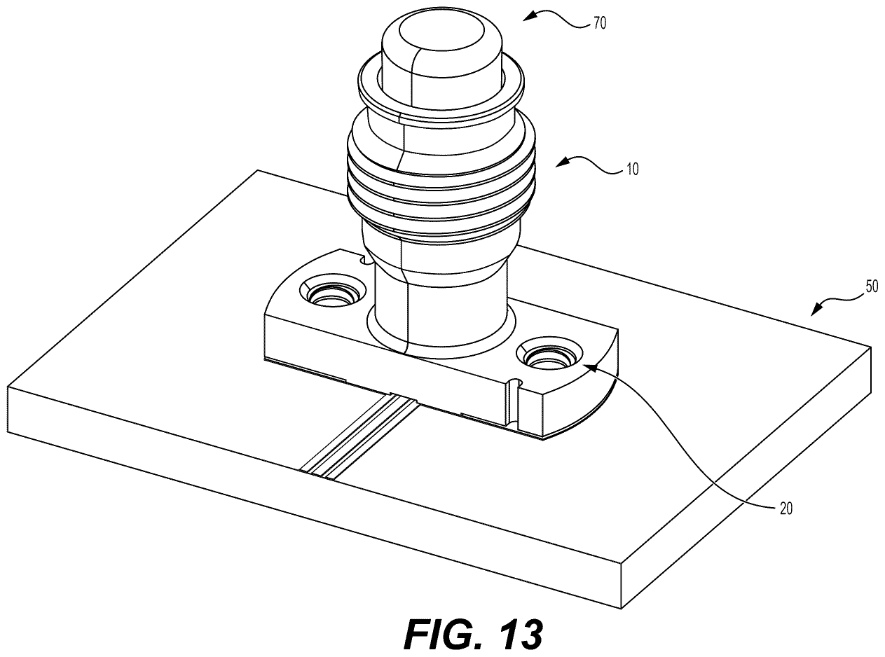

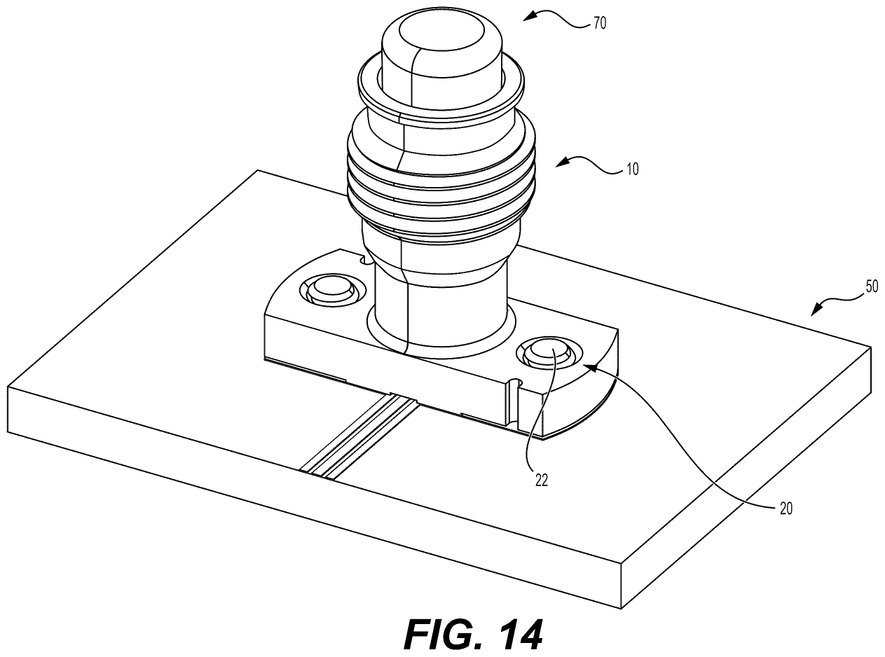

FIGS. 13 and 14 are top perspective views of the RF connector 10 being mounted to the substrate 50. As shown in FIG. 13, the RF connector 10 is placed on the substrate 50 and the alignment peg 70 is inserted in the RF connector 10. The alignment peg 70 is then rotated until the embossed portion 76 engages with the traces on the substate 50, for example, the signal trace 52 and the ground plane 56. As shown in FIG. 14, the screws 22 are inserted through the substrate fastener holes 58 and into the connector fastener holes 20. With the alignment peg 70 in place to properly align the RF connector 10 to the substrate 50, the screws 22 are tightened to secure the RF connector 10 to the substrate 50. The alignment peg 70 can then be removed and the core 30 can be inserted into the RF connector 10, as shown in FIGS. 8 and 9. Since the alignment peg 70 can align the RF connector 10 to the substrate 50, proper alignment between the center conductor 31 of the core 30 and the signal trace 52 of the substrate 50 can be provided.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure is not limited to the particular embodiments disclosed for carrying out this disclosure, but that the disclosure will include all embodiments falling within the scope of the appended claims.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

1. An electrical connector comprising:
an electrically conductive connector housing; and
a core that:
is removably inserted into the connector housing; and
includes a center conductor, a ground conductor, and an insulating spacer provided between the center conductor and the ground conductor; wherein
the core can be removed and reinserted into the connector housing without damaging the connector housing or the core.

2. (canceled)

3. The electrical connector according to claim 1, wherein the insulating spacer includes a dielectric material.

4. The electrical connector according to claim 1, wherein the insulating spacer includes one or more void spaces.

5. The electrical connector according to claim 1, wherein the insulating spacer defines a lattice structure.

6. The electrical connector according to claim 1, wherein at least one of the center conductor and the ground conductor is tapered along a length of the core.

7. The electrical connector according to claim 1, wherein the center conductor includes a recess that receives a pin of a mating connector or cable, when the electrical connector is mated with the mating connector or cable.

8. The electrical connector according to claim 1, wherein the center conductor is at least partially exposed from the core at a surface of the core that mates with a substrate, when the electrical connector mates with the substrate.

9. The electrical connector according to claim 1, wherein the ground conductor is at least partially exposed from the core at a surface of the core that mates with a mating connector or cable, when the electrical connector is mated with the mating connector or cable.

10. The electrical connector according to claim 1 wherein the ground conductor is at least partially exposed from the core at a surface of the core that mates with a substrate, when the electrical connector mates with the substrate.

11. The electrical connector according to claim 10, wherein the portion of the ground conductor that is at least partially exposed from the core at a surface of the core includes a cut-out or recessed portion.

12. The electrical connector according to claim 1, wherein:
the connector housing includes a ridge located within a port of the connector housing; and
the core includes a beveled surface that mates with the ridge when the core is inserted into the connector housing.

13. A method of manufacturing a core of an electrical connector, the method comprising:
forming a portion of the core by an additive manufacturing process; and
placing the portion of the core in a shell; wherein
the additive manufacturing process includes forming a center conductor, an insulating spacer, and a ground conductor,
the insulating spacer is located between the center conductor and the ground conductor, and
the core can be removed and reinserted into a connector housing without damaging the connector housing or the core.

14. (canceled)

15. The method according to claim 13, wherein the insulating spacer is formed with one or more void spaces.

16. The method according to claim 15, wherein the void spaces are formed in a lattice or matrix structure.

17. The method according to claim 13, wherein the insulating spacer is formed to provide a predetermined dielectric constant.

18. The method according to claim 13, wherein at least one of the center conductor and the ground conductor is tapered along a length of the core.

19. (canceled)

20. A RF compression connector comprising:
an electrically conductive housing; and
a core made by three-dimensional printing that can be removed and reinserted into the housing without damaging the housing or the core, the core including a center conductor, a ground conductor, and an insulating spacer provided between the center conductor and the ground conductor.

21.-22. (canceled)

23. The RF compression connector of claim 20, wherein the insulating spacer is provided between the center conductor and the ground conductor such that there are void spaces between the center conductor and the ground conductor.

24. The RF compression connector of claim 20, wherein
the insulating spacer includes a shell and spokes; and
the spokes extend between the center conductor and the shell.

25. The RF compression connector of claim 24, wherein the shell partially surrounds the ground conductor.
